(19) United States
(12) Patent Application Publication
(10) Pub. No.: US 2026/0066679 A1
(43) Pub. Date: Mar. 5, 2026

(54) PORTABLE ENERGY STORAGE DEVICE CAPABLE OF SIMULTANEOUS MULTI-PORT DISCHARGE AND POWER ALLOCATION METHOD

(71) Applicant: NINGBO SOYAR TECHNOLOGY INNOVATION CO., LTD., Ningbo (CN)

(72) Inventor: Tao HUANG, Ningbo (CN)

(73) Assignee: NINGBO SOYAR TECHNOLOGY INNOVATION CO., LTD., Ningbo (CN)

(21) Appl. No.: 19/316,614

(22) Filed: Sep. 2, 2025

(30) Foreign Application Priority Data
Sep. 4, 2024 (CN) 202411236766X

(51) Int. Cl. H02J 7/00

(52) U.S. Cl. CPC H02J 7/50; H02J 7/62; H02J 7/64; H02J 7/65; H02J 7/663; H02J 7/94; H02J 7/96

(57) ABSTRACT

A portable energy storage device capable of simultaneous multi-port discharge and power allocation method, the device including multiple charging output ports, all or part of which have different preset power distribution priorities, enabling the user to determine the priority sequence of multiple power-receiving devices according to actual needs when using the device. Furthermore, when multiple charging output ports are all connected to power-receiving devices and the sum of the required power of the power-receiving devices exceeds the maximum power that the device can provide, all ports can still operate at their respective preset minimum power. If there is remaining power, the remaining power is preferentially allocated to the charging output ports with higher priority. Furthermore, when the number of charging output ports connected to power-receiving devices changes, the device reallocates power, thereby achieving dynamic power adjustment and enabling the device to operate at its maximum output power whenever possible.

### FILED OF THE INVENTION

The invention relates to the technical field of portable energy storage devices, and in particular to a portable energy storage device capable of simultaneous multi-port discharge and power allocation method.

### BACKGROUND

With the increasing popularity of mobile devices and the growing number of outdoor activities, the demand for portable energy storage devices has been rising steadily. Whether for outdoor camping, emergency power needs, or daily charging of mobile devices, portable energy storage devices capable of providing reliable power have become indispensable tools.

In the prior art, portable energy storage devices have evolved to feature multiple charging output ports, each of which can be connected to an electronic device for charging. However, in such devices, the output power of each charging output port is either fixed—for example, in a device with three charging output ports, each port may be limited to an output power of 50 W. In this case, even when only one charging output port is in use, it can still operate only at 50 W, resulting in the inability to achieve maximum single-port output. Alternatively, some devices support maximum power output for a given charging output port through complex power distribution logic, but this approach is complicated to operate and provides a poor user experience.

For example, Chinese Patent CN112671055B, in its earlier application, seeks protection for a power distribution method and a charging device, wherein power is allocated to each output port according to the connection sequence of the devices and the power demand of each connected device. Paragraphs to of its specification describe in detail the specific process of allocating power to the first, second, and third output ports according to the order in which the devices are connected. In brief: assuming that the total power available from the charging device is 100 W, when a first device occupies 60 W of power via the first output port, the remaining power of the charging device is 40 W. When a second device is connected to the second output port, and its maximum charging power is 100 W, since this exceeds the remaining 40 W, the second device charges at 40 W. When a third device is connected to the third output port, assuming that its maximum charging power is 150 W and its minimum charging power is 15 W, since the total power of 100 W has already been fully allocated to the first and second output ports, the system first satisfies the third device's minimum charging power of 15 W and correspondingly reduces the power supplied to the first and second devices.

It is thus apparent that Chinese Patent CN112671055B determines the priority of power allocation based on the sequence in which electronic devices are connected to the charging device—namely, the earlier a device is connected, the higher its priority for having its power demand satisfied. This means that if a user wishes to give priority to a later-connected device, they would need to disconnect all devices currently being charged in order to reorder the priority. Such an operation is detrimental to both the charging device and the electronic devices, and also results in a poor user experience.

### SUMMARY OF THE INVENTION

To address the shortcomings of the prior art, the objective of the present invention is to provide a portable energy storage device capable of simultaneous multi-port discharge, as well as a power allocation method applicable to such a portable energy storage device. By predefining the priorities of multiple charging output ports, the invention enables the user, during operation, to select a charging output port of a particular priority according to actual needs, thereby allowing for the advance and reasonable arrangement of the connection relationship between the electronic devices to be charged and the charging output ports.

To achieve the above-mentioned objective, the present invention provides the following technical solution:

According to the first aspect of the present invention, a portable energy storage device capable of simultaneous multi-port discharge is provided, comprising a power configuration unit and at least two charging output ports, wherein the power configuration unit is configured to allocate power to the charging output ports connected to power-receiving devices, each charging output port being preset with a power distribution priority, a minimum output power, and a maximum output power; defining the maximum total output power of the energy storage device as Pmax_out, and the number of charging output ports connected to power-receiving devices as Y, defining, in order from highest to lowest priority, the ports as the first to the Y-th charging output ports, their minimum output powers as Pmin_c1 to Pmin_cY, and the smaller of their maximum output power and load request power as the first to the Y-th preset powers; wherein, when Y≥2 and the Y charging output ports have different priorities:

if (Pmin_c1+ . . . +Pmin_cY)<Pmax_out<(first preset power+ . . . +Y-th preset power), the power configuration unit first satisfies the minimum output power of said ports, and then allocates the remaining power sequentially according to priority, defining the initial amount of remaining power as P0_out, and the remaining power allocation rule as follows:

during the first round of remaining power allocation, the power configuration unit allocates to the first charging output port a total power equal to the smaller of (Pmin_c1+remaining power P0_out) and the first preset power; defining the remaining power obtained by the first charging output port after the first round of allocation as C1, C1=total power allocated to the first charging output port−Pmin_c1; defining the remaining power after the first round as P1_out, P1_out=P0_out−C1; if P1_out=0, power allocation ends; if P1_out>0, the following rule is applied to continue allocating remaining power until the remaining power Pk_out=0, thereby ending power allocation: during the k-th round of remaining power allocation, the power configuration unit allocates to the k-th charging output port the smaller of (Pmin_ck+remaining power Pk-1_out) and the k-th preset power as the total power obtained; defining the remaining power obtained by the k-th charging output port after the k-th round as Ck, Ck=total power allocated to the k-th charging output port−Pmin_ck; defining the remaining power after the k-th round as Pk_out, Pk_out=P0_out−C1 . . . Ck, where k is a positive integer and k≥2.

Furthermore, when Y≥2 and all of the Y charging output ports have the same lowest priority, if Pmax_out<the sum of the preset powers of these ports, the power configuration unit first satisfies the minimum output power of said ports and then evenly allocates the remaining power.

Furthermore, when Y≥3 and among the Y charging output ports, x ports have the same lowest priority and the remaining (Y−x) ports have different priorities, where 2≤x<Y:
if (Pmin_c1+ . . . +Pmin_cY)<Pmax_out<(first preset power+ . . . +Y-th preset power), the power configuration unit first satisfies the minimum output power of said ports, and then allocates the remaining power sequentially according to priority, defining the initial amount of remaining power as P0_out, with the allocation rule as follows:
during the first round of remaining power allocation, the power configuration unit allocates to the first charging output port a total power equal to the smaller of (Pmin_c1+remaining power P0_out) and the first preset power; defining the remaining power obtained by the first charging output port after the first round as C1, C1=total power allocated to the first charging output port−Pmin_c1; defining the remaining power after the first round as P1_out, P1_out=P0_out−C1; if P1_out=0, power allocation ends; if P1_out>0 and only x charging output ports remain unallocated with remaining power, the power configuration unit evenly distributes the remaining power P1_out to the x charging output ports, and power allocation ends; if P1_out>0 and more than x charging output ports remain unallocated, the power configuration unit continues allocation according to the following rule until either Condition 1 or Condition 2 is met:
the remaining power allocation rule is as follows: during the k-th round of remaining power allocation, the power configuration unit allocates to the k-th charging output port the smaller of (Pmin_ck+remaining power Pk-1_out) and the k-th preset power as the total power obtained; the remaining power obtained by the k-th charging output port after the k-th round of allocation is defined as Ck, and the remaining power thereafter as Pk_out, where Ck=total power allocated to the k-th charging output port−Pmin_ck, and Pk_out=P0_out−C1 . . . Ck;
the condition 1 is that the remaining power Pk_out is 0; the condition 2 is that the remaining power Pk_out>0 and, at this point, only x charging output ports have not yet been allocated remaining power; if Condition 1 is met first, the power allocation ends; if Condition 2 is met first, the remaining power Pk_out is evenly distributed among the remaining x charging output ports, and the power allocation ends, where k is a positive integer and k≥2.

Furthermore, if Pmax_out=(Pmin_c1+ . . . +Pmin_cY), the power configuration unit allocates to each charging output port connected to a power-receiving device its corresponding minimum output power; if Pmax_out≥(first preset power+ . . . +Y-th preset power), the power configuration unit allocates to each charging output port connected to a power-receiving device its corresponding preset power.

Furthermore, when Y=1, the power configuration unit allocates to the charging output port a power equal to the smaller of its maximum output power and the requested load power as the allocated power.

Furthermore, the portable energy storage device comprises a main control board and one or more independent circuit boards connected to the main control board, the charging output ports provided on the circuit boards, and the power configuration unit being disposed on the main control board.

Furthermore, the power configuration unit reads preset parameters of the charging output ports, calculates the real-time power demand of each charging output port, and allocates discharge power accordingly, the preset parameters including current and voltage.

Furthermore, protection circuits are provided on both the circuit boards and the main control board, the protection circuits comprising one or more of: an over-current protection circuit, an over-voltage protection circuit, an over-temperature protection circuit, and a short-circuit protection circuit, and when an abnormal condition is detected, the protection circuit responds and interrupts the power supply of the relevant circuit.

According to the second aspect of the present invention, a power allocation method for a portable energy storage device is provided, applied to the portable energy storage device according to the first aspect of the present invention, the method comprising:
when the number of charging output ports connected to power-receiving devices Y≥2 and all of the Y charging output ports have different priorities: if (Pmin_c1+ . . . +Pmin_cY)<Pmax_out<(first preset power+ . . . +Y-th preset power), the power configuration unit first satisfies the minimum output power of the charging output ports, and then allocates the remaining power sequentially according to priority, defining the initial amount of remaining power as P0_out, with the allocation rule as follows:
during the first round of remaining power allocation, the power configuration unit allocates to the first charging output port a total power equal to the smaller of (Pmin_c1+remaining power P0_out) and the first preset power; defining the remaining power obtained by the first charging output port after the first round as C1, C1=total power allocated to the first charging output port−Pmin_c1; defining the remaining power after the first round as P1_out, P1_out=P0_out−C1; if P1_out=0, power allocation ends; if P1_out>0, the following rule is applied to continue allocation until the remaining power Pk_out=0, thereby ending power allocation: during the k-th round of remaining power allocation, the power configuration unit allocates to the k-th charging output port the smaller of (Pmin_ck+remaining power Pk-1_out) and the k-th preset power as the total power obtained; defining the remaining power obtained by the k-th charging output port after the k-th round as Ck, Ck=total power allocated to the k-th charging output port-Pmin_ck; defining the remaining power after the k-th round as Pk_out, Pk_out=P0_out−C1 . . . Ck, where k is a positive integer and k≥2.

Furthermore, when the number of charging output ports connected to power-receiving devices Y>2 and the Y charging output ports all have the same lowest priority, if Pmax_out<the sum of the preset powers of the charging output ports, the power configuration unit first satisfies the minimum output power of the charging output ports and then evenly allocates the remaining power; when the number of charging output ports connected to power-receiving devices Y≥3 and among the Y charging output ports x ports have the same lowest priority and the remaining (Y−x) ports have different priorities, where 2≤x<Y:
if (Pmin_c1+ . . . +Pmin_cY)<Pmax_out<(first preset power+ . . . +Y-th preset power), the power configuration unit first satisfies the minimum output power of the charging output ports, and then allocates the remaining power sequentially according to priority, defining the initial amount of remaining power as P0_out, with the allocation rule as follows:
during the first round of remaining power allocation, the power configuration unit allocates to the first charging output port the smaller of (Pmin_c1+remaining power P0_out) and the first preset power as the total power obtained; defining the remaining power obtained by the first charging output port after the first round as C1, C1=total power allocated to the first charging output port−Pmin_c1; defining the remaining power after the first round as P1_out, P1_out=P0_out−C1; if P1_out=0, power allocation ends; if P1_out>0 and only x charging output ports remain unallocated with remaining power, the power configuration unit evenly distributes the remaining power P1_out to the x charging output ports, and power allocation ends; if P1_out>0 and more than x charging output ports remain unallocated, the power configuration unit continues allocation according to the following rule until either Condition 1 or Condition 2 is met:
the remaining power allocation rule is as follows: during the k-th round of remaining power allocation, the power configuration unit allocates to the k-th charging output port the smaller of (Pmin_ck+remaining power Pk-1_out) and the k-th preset power as the total power obtained; defining the remaining power obtained by the k-th charging output port after the k-th round as Ck, Ck=total power allocated to the k-th charging output port−Pmin_ck; defining the remaining power after the k-th round as Pk_out, Pk_out=P0_out−C1− . . . −Ck;
the condition 1 is that the remaining power Pk_out is 0; the condition 2 is that remaining power Pk_out>0 and only x charging output ports remain unallocated with remaining power; if Condition 1 is met first, power allocation ends; if Condition 2 is met first, the remaining power Pk_out is evenly distributed to the remaining x charging output ports, and power allocation ends, where k is a positive integer and k≥2.

Compared with the prior art, the present invention provides the following advantages:

1. The portable energy storage device and the power allocation method of the present invention ensure that when multiple charging output ports are connected to power-receiving devices and the total required power exceeds the maximum power the device can provide, all ports can still operate at their preset minimum power.

2. According to the portable energy storage device and power allocation method provided by the present invention, after multiple charging output ports are connected to power-receiving devices and power is allocated according to preset rules, if a power-receiving device is removed from a charging output port during operation, thereby changing the number of connected ports, power is reallocated according to the preset rules based on the current number of connected ports. In this way, the power released from the removed device can be redistributed to the remaining connected ports, enabling the portable energy storage device to output power as close as possible to its maximum capacity and achieve dynamic adjustment.

3. According to the portable energy storage device and power allocation method provided by the present invention, all or some of the charging output ports can have different preset priorities. As a result, users can set the priority order of multiple power-receiving devices according to actual needs, making the device convenient and easy to operate.

### BRIEF DESCRIPTION OF THE DRAWINGS

Other features, objectives, and advantages of the present invention will become apparent from the following detailed description of non-limiting embodiments in conjunction with the accompanying drawings:

FIG. 1 is a schematic diagram of the structure of a portable energy storage device according to the first embodiment of the present invention, in which the number of charging output ports is two;

FIG. 2 is a schematic diagram of the structure of a portable energy storage device according to the second embodiment of the present invention, in which the number of charging output ports is three;

FIG. 3 is a schematic diagram of the structure of the portable energy storage device according to the second embodiment of the present invention, in which the number of charging output ports is four.

In the drawings:
301—first charging output port;
302—second charging output port;
303—third charging output port;
304—fourth charging output port;
201—power configuration unit.

### EMBODIMENT

To clarify the purpose, technical solution, and advantages of the embodiments described herein, the following detailed description of the embodiments provided in the accompanying drawings is presented. It is understood that the described embodiments are part of this application, and not all possible embodiments are depicted. Components shown and described in the drawings can be arranged and designed in various configurations.

Therefore, the detailed description of the embodiments provided in the drawings is not intended to limit the scope of the claims of this application, but only to represent selected embodiments thereof. All other embodiments obtained by those skilled in the art without creative labor based on the embodiments disclosed herein are within the scope of protection of this application.

It should be noted that similar numerals and letters in the following drawings represent similar elements. Therefore, once an element is defined in one drawing, it does not need to be further defined or explained in subsequent drawings. Additionally, all directional indications (such as up, down, left, right, front, rear, bottom, etc.) used in this application are for explaining the relative positional relationships and movements of the components in a specific orientation (as shown in the drawings). If this specific orientation changes, the directional indications also change Accordingly. Furthermore, descriptions involving “first,” “second,” etc., are used for descriptive purposes only and should not be construed to indicate or imply relative importance or the quantity of the indicated technical features.

### Embodiment 1

In this embodiment, a portable energy storage device capable of simultaneous multi-port discharge is provided. Structurally, the energy storage device is made of a lightweight and high-strength housing material. Inside, one or more independent circuit boards are provided, each equipped with power input and charging output ports, and connected to a main control board via wiring. The main control board is embedded with an intelligent control chip that includes a power configuration unit 201 configured to execute a power distribution algorithm. The power configuration unit 201 calculates the real-time power demand of each port by reading parameters such as current and voltage from each port, and accordingly adjusts the charging and discharging power of each port. In addition, both the circuit boards and the main control board are provided with overcurrent protection, overvoltage protection, overtemperature protection, and short-circuit protection components. When an abnormal condition is detected, these protection circuits respond quickly and cut off the power supply to the relevant circuit. Since the core of this embodiment lies in the power distribution logic of the energy storage device when operating in discharge-only mode, the specific details are described as follows:

The portable energy storage device provided in this embodiment, capable of discharging through multiple ports simultaneously, comprises at least two charging output ports and a power configuration unit 201. The power configuration unit 201 is configured to allocate power to the charging output ports connected to power-receiving devices; that is, if a charging output port is not connected to a power-receiving device, no power is allocated to that port. As used herein, a ‘power-receiving device’ refers to a device being charged, such as a mobile phone, a camera, or the like.

Each charging output port is preset with a power allocation priority. For charging output ports with a higher priority, the power configuration unit 201 will, during power allocation, give precedence to meeting the required power of such ports. Each charging output port is preset with a minimum output power and a maximum output power. ‘Minimum output power’ refers to the minimum power the power configuration unit will allocate to the port, while ‘maximum output power’ refers to the maximum power the power configuration unit will allocate to the port.

The maximum total output power of the portable energy storage device provided in this embodiment is defined as Pmax_out (in the present application, the sum of the preconfigured minimum output powers of the charging output ports is less than or equal to Pmax_out; the minimum output power of each charging output port is less than or equal to its maximum output power; and the maximum output power of each charging output port is less than or equal to Pmax_out). The number of charging output ports connected to power-receiving devices is defined as Y (it should be understood that Y is less than or equal to the total number of charging output ports of the portable energy storage device).

When Y=1, only one charging output port is connected to a power-receiving device, the power configuration unit 201 allocates to that port the smaller of its maximum output power and the load request power (for convenience, in some descriptions herein, the power allocated to a port is referred to as the “allocated power” of that port). The term “load request power” refers to the power required by the power-receiving device, as a load, under normal operating conditions, which may vary depending on the specific device connected.

Specifically, if the load request power of the charging output port is greater than the port's maximum output power, the port reports the maximum power it can support (i.e., the maximum output power), and the power configuration unit 201 sets the port's allocated power to its maximum output power. If the load request power of the port is less than its maximum output power, the power configuration unit 201 sets the port's allocated power to its load request power. If the load request power of the port is equal to its maximum output power, the power configuration unit 201 sets the port's allocated power to the load request power (which equals the port's maximum output power.

When Y≥2 and the Y charging output ports have different priorities: the ports are sorted in descending order of priority and sequentially defined as the first charging output port through the Y-th charging output port. Their minimum output powers are sequentially defined as Pmin_c1 to Pmin_cY, and the smaller of each port's maximum output power and load request power is sequentially defined as the first preset power through the Y-th preset power.

If Pmax_out=(Pmin_c1+ . . . +Pmin_cY), that is, the maximum total output power of the portable energy storage device equals the sum of the minimum output powers of the charging output ports connected to power-receiving devices, the power configuration unit allocates to each connected charging output port its corresponding minimum output power.

If Pmax_out≥(first preset power+ . . . +Y-th preset power), that is, the maximum total output power of the portable energy storage device is greater than or equal to the sum of the preset powers of the charging output ports connected to power-receiving devices, the power configuration unit allocates to each connected charging output port its corresponding preset power.

If (Pmin_c1+ . . . +Pmin_cY)<Pmax_out<(first preset power+ . . . +Y-th preset power), the power configuration unit 201 first satisfies the minimum output power of these charging output ports (i.e., it first allocates to each charging output port connected to a power-receiving device its corresponding minimum output power), and then sequentially allocates the remaining power according to priority. The initial amount of remaining power is defined as P0_out, where: P0_out=Pmax_out−(Pmin_c1+ . . . +Pmin_cY). The allocation rule for the remaining power is as follows:

During the first round of remaining power allocation, the power configuration unit 201 allocates to the first charging output port 301 the lesser of (Pmin_c1+P0_out) and the first preset power as the total power allocated to the port. The additional power obtained by the first charging output port 301 after the first round is defined as C1, where: C1=total power allocated to the first charging output port 301−Pmin_c1. The remaining power after the first round is defined as P1_out, where: P1_out=P0_out−C1. If P1_out=0, the power allocation ends. If P1_out>0, allocation continues according to the following rule until the remaining power Pk_out=0, at which point the allocation ends:

During the k-th round of remaining power allocation, the power configuration unit 201 allocates to the k-th charging output port the lesser of (Pmin_ck+Pk-1_out) and the k-th preset power as the total power allocated to the port. The additional power obtained by the k-th charging output port after the k-th round is defined as Ck, where: Ck=total power allocated to the k-th charging output port−Pmin_ck. The remaining power after the k-th round is defined as Pk_out, where: Pk_out=P0_out−C1 . . . Ck, with k being a positive integer and k≥2.

It can be understood that when Y=2, i.e., when two charging output ports with different priorities are connected to power-receiving devices, as shown in FIG. 1, the two charging output ports are ordered in descending priority and sequentially defined as the first charging output port 301 and the second charging output port 302. Their minimum output powers are respectively defined as Pmin_c1 and Pmin_c2, and the lesser of their maximum output power and load request power is respectively defined as the first preset power and the second preset power.

If Pmax_out=(Pmin_c1+Pmin_c2), the power configuration unit allocates Pmin_c1 to the first charging output port and Pmin_c2 to the second charging output port.

If Pmax_out≥(the first preset power+the second preset power), the power configuration unit allocates the first preset power to the first charging output port and the second preset power to the second charging output port.

If (Pmin_c1+Pmin_c2)<Pmax_out<(the first preset power+the second preset power), the power configuration unit 201 first satisfies the minimum output power requirements of the first charging output port 301 and the second charging output port 302 (i.e., allocating Pmin_c1 to the first charging output port and Pmin_c2 to the second charging output port), and then sequentially allocates the remaining power in accordance with the priority order. The initial amount of remaining power is defined as P0_out, where: P0_out=Pmax_out−(Pmin_c1+Pmin_c2).

During the first round of remaining power allocation, the power configuration unit 201 allocates to the first charging output port 301 a total power equal to the lesser of (Pmin_c1+P0_out) and the first preset power. After this allocation, the additional power obtained by the first charging output port 301 is: C1=(total power allocated to the first charging output port 301)−Pmin_c1. The remaining power after the first round is: P1_out=P0_out−C1. If P1_out=0, the power allocation ends. In this case, the total power allocated to the first charging output port 301 is (Pmin_c1+P0_out), and the total power allocated to the second charging output port 302 remains at its minimum output power.

If P1_out>0, this indicates that the first charging output port 301 has already reached the first preset power and that there is still remaining power available for further allocation to the second charging output port 302. Therefore, a second round of remaining power allocation is performed. At this stage, the power configuration unit 201 assigns to the second charging output port a total power equal to the lesser of (Pmin_c2+remaining power P1_out) and the second preset power. It can be understood that since Pmax_out<(the first preset power+the second preset power), (Pmin_c2+remaining power P1_out) is necessarily less than the second preset power. Accordingly, the power configuration unit 201 directly assigns the remaining power P1_out to the second charging output port 302, such that the total power allocated to the second charging output port 302 becomes (Pmin_c2+P1_out). After the second round of allocation, the additional power obtained by the second charging output port 302 is C2=(the total power allocated to the second charging output port 302−Pmin_c2)=P1_out. The remaining power after the second round is P2_out=P0_out−C1−C2=0, and the power allocation ends. This means that the total power allocated to the first charging output port 301 is the first preset power, and the total power allocated to the second charging output port 302 is (Pmin_c2+P1_out).

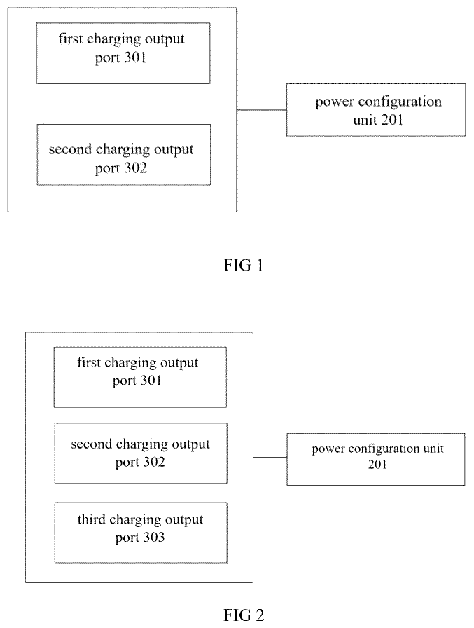

Accordingly, as shown in FIG. 2, when Y=3, i.e., when three charging output ports with different priorities are connected to power-receiving devices, the charging output ports are sequentially defined, in order of priority from high to low, as the first charging output port 301, the second charging output port 302, and the third charging output port 303. Their minimum output powers are sequentially defined as Pmin_c1, Pmin_c2, and Pmin_c3, respectively, and the smaller value between their maximum output power and the requested load power is defined as the first preset power, the second preset power, and the third preset power, respectively.

If Pmax_out=(Pmin_c1+Pmin_c2+Pmin_c3), the power configuration unit assigns Pmin_c1, Pmin_c2, and Pmin_c3 to the first, second, and third charging output ports, respectively.

If Pmax_out≥(the sum of the first, second, and third preset powers), the power configuration unit assigns the first, second, and third preset powers to the first, second, and third charging output ports, respectively.

If (Pmin_c1+Pmin_c2+Pmin_c3)<Pmax_out<(the first preset power+the second preset power+the third preset power), the power configuration unit 201 first satisfies the minimum output power requirements of the charging output ports (i.e., it first allocates to each charging output port its corresponding minimum output power), and then sequentially allocates the remaining power in order of priority. The initial amount of the remaining power is defined as P0_out, where P0_out=Pmax_out−(Pmin_c1+Pmin_c2+Pmin_c3). The allocation rule is as follows:

During the first round of remaining power allocation, the power configuration unit 201 assigns to the first charging output port 301 a total power equal to the lesser of (Pmin_c1+P0_out) and the first preset power. After the first round, the additional power allocated to the first charging output port 301 is C1=(the total power assigned-Pmin_c1). The remaining power is then P1_out=P0_out−C1. If P1_out=0, the allocation ends. This means that the total power assigned to the first charging output port 301 is (Pmin_c1+P0_out), while the second charging output port 302 and the third charging output port 303 are assigned their respective minimum output powers.

If P1_out>0, this indicates that the first charging output port 301 has already reached the first preset power and that there is still remaining power available for further allocation to the second charging output port 302. Therefore, a second round of allocation is performed. The power configuration unit 201 assigns to the second charging output port 302 a total power equal to the lesser of (Pmin_c2+P1_out) and the second preset power. After the second round, the additional power allocated to the second charging output port 302 is C2=(the total power assigned-Pmin_c2). The remaining power is P2_out=P0_out−C1−C2. If P2_out=0, the allocation ends. This means that the total power assigned to the first charging output port 301 is the first preset power, the total power assigned to the second charging output port 302 is (Pmin_c2+P1_out), and the total power assigned to the third charging output port 303 is its minimum output power.

If P2_out>0, this indicates that the second charging output port 302 has already reached the second preset power and that there is still remaining power available for further allocation to the third charging output port 303. Therefore, a third round of allocation is performed. The power configuration unit 201 assigns to the third charging output port 303 a total power equal to the lesser of (Pmin_c3+P2_out) and the third preset power. Since Pmax_out<(the sum of the first, second, and third preset powers), it follows that (Pmin_c3+P2_out) is necessarily less than the third preset power. Accordingly, the power configuration unit 201 directly allocates the remaining power P2_out to the third charging output port 303, so that the total power assigned to the third charging output port 303 becomes (Pmin_c3+P2_out). After the third round, the additional power allocated to the third charging output port 303 is C3=(the total power assigned-Pmin_c3), which equals P2_out. The remaining power after the third round is P3_out=P0_out−C1−C2−C3=0, marking the end of the allocation. This means that the total power assigned to the first charging output port 301 is the first preset power, the total power assigned to the second charging output port 302 is the second preset power, and the total power assigned to the third charging output port 303 is (Pmin_c3+P2_out).

When Y takes other values, those skilled in the art can derive the corresponding power allocation scenarios based on the above description of this embodiment.

The portable energy storage device provided in this embodiment ensures that, when multiple charging output ports are connected to power-receiving devices and the total power required by these devices exceeds the maximum power that the energy storage device can supply, all ports are guaranteed to operate at their preset minimum power. Furthermore, after multiple charging output ports are connected to power-receiving devices and power is allocated according to the above rules, if, during operation, a power-receiving device is removed from one of the charging output ports, resulting in a change in the number of connected ports, the power will be reallocated based on the current number of connected power-receiving devices in accordance with the same rules. This ensures that the power released from the removed device can be redistributed to the remaining connected ports, thereby allowing the portable energy storage device to operate as close as possible to its maximum available output power and achieve dynamic power adjustment. Additionally, the portable energy storage device provided in this embodiment is configured with charging output ports having different priority levels that are preset in advance. Accordingly, users can determine the priority order of multiple power-receiving devices according to actual requirements, thereby ensuring convenient use and user-friendly operation.

It should be particularly noted that, as described above, in this embodiment, the so-called minimum output power and maximum output power refer to the minimum and maximum power that the power configuration unit can allocate to the corresponding port. Specifically, when a charging output port is connected to a power-receiving device and the requested load power of the device is 15 W, while the minimum output power of that port is 20 W, the power configuration unit will allocate at least the minimum output power to the port, i.e., at least 20 W. However, since the load only requires 15 W, the actual operating power of the charging output port will be 15 W, and the excess 5 W will not be redistributed to other ports. This design thereby achieves the aforementioned goal of ensuring that “all ports can operate at their preset minimum power,” and differs from prior art approaches in which the minimum allocation power is defined as the minimum allowable operating power of the power-receiving device. As a result, the device can operate in a more stable manner, with more rational and reliable power allocation.

The following provides a further illustration of the technical solution of this embodiment by substituting specific numerical values:

### I. When Only One Charging Output Port is Connected to a Power-Receiving Device

Assume that the load power requested by this charging output port is 100 W, and the maximum output power of the port is 50 W. Since the requested load power exceeds the maximum output power, the power configuration unit 201 allocates a power equal to the maximum output power of the port, i.e., 50 W.

Assume that the load power requested by this charging output port is 100 W, and the maximum output power of the port is 150 W. Since the requested load power is less than the maximum output power, the power configuration unit 201 allocates a power equal to the requested load power, i.e., 100 W.

### II. When Two Charging Output Ports are Connected to Power-Receiving Devices

In accordance with the priority order of the connected charging output ports, the two ports are designated as the first charging output port 301 and the second charging output port 302. The preset values for these ports are shown in Table 1:

TABLE 1

| | the first charging | the second charging |
|---|---|---|
| Relevant parameters | output port 301 | output port 302 |
| Minimum output power (Pmin) | 20 W | 30 W |
| Maxmum output power (Pmax) | 40 W | 50 W |
| Requested load power | 30 W | 60 W |
| Preset power | 30 W | 50 W |

Assume Pmax_out=100 W. Since Pmax_out>(the first preset power+the second preset power), the power configuration unit 201 assigns powers equal to their respective preset powers to the first and second charging output ports 301 and 302. That is, the power allocated to the first charging output port 301 is 30 W, and the power allocated to the second charging output port 302 is 50 W.

Assume Pmax_out=50 W. Since Pmax_out=(Pmin_c1+Pmin_c2), the power configuration unit 201 assigns powers equal to their respective minimum output powers to the first charging output port 301 and the second charging output port 302. That is, the power allocated to the first charging output port 301 is 20 W, and the power allocated to the second charging output port 302 is 30 W.

Assume Pmax_out=55 W. Since (Pmin_c1+Pmin_c2)<Pmax_out<(the first preset power+the second preset power), the power configuration unit 201 first ensures the minimum output power of the first charging output port 301 and the second charging output port 302, i.e., it first allocates power according to their minimum output powers. The remaining power after this allocation is P0_out=Pmax_out−(Pmin_c1+Pmin_c2)=55 W−50 W=5 W. The rule for allocating this remaining power 5 W is as follows

During the first round of remaining power allocation, the power configuration unit 201 assigns a total of 25 W to the first charging output port 301, which is the smaller value between (Pmin_c1+remaining power P0_out) and the first preset power. Since (Pmin_c1+P0_out)=25 W and the first preset power is 30 W, the power configuration unit 201 assigns 25 W as the total power to the first charging output port 301. The additional power allocated to the first charging output port 301 is C1=total power assigned-Pmin_c1=25 W−20 W=5 W. The remaining power after the first round is P1_out=P0_out−C1=5 W−5 W=0. Since P1 out=0, the power allocation ends. This means that the total power assigned to the first charging output port 301 is (Pmin_c1+remaining power P0_out), i.e., 25 W, and the total power assigned to the second charging output port 302 is its minimum output power, i.e., 30 W.

Assume Pmax_out=70 W. Since (Pmin_c1+Pmin_c2)<Pmax_out<(the first preset power+the second preset power), the power configuration unit 201 first ensures the minimum output power of the first charging output port 301 and the second charging output port 302. The remaining power after this allocation is P0_out=Pmax_out−(Pmin_c1+Pmin_c2)=70 W−50 W=20 W. The allocation rule for this remaining 20 W is as follows:

During the first round of remaining power allocation, the power configuration unit 201 assigns to the first charging output port 301 a total power equal to the smaller value between (Pmin_c1+remaining power P0_out) and the first preset power. Since (Pmin_c1+P0_out)=40 W and the first preset power is 30 W, the power configuration unit 201 assigns 30 W as the total power for the first charging output port 301. The remaining power allocated to the first charging output port 301 is C1=total power assigned-Pmin_c1=30 W−20 W=10 W. The remaining power after the first round is P1_out=P0_out−C1=20 W−10 W=10 W.

Since P1_out>0, a second round of remaining power allocation is performed. At this stage, the power configuration unit 201 assigns to the second charging output port 302 a total power equal to the smaller value between (Pmin_c2+remaining power P1_out) and the second preset power. Since Pmax_out<(the first preset power+the second preset power), (Pmin_c2+P1_out)=40 W is less than the second preset power (50 W). Therefore, the power configuration unit 201 directly allocates the remaining power P1_out=10 W to the second charging output port 302, so that the total power assigned to the second charging output port 302 becomes (Pmin_c2+P1_out)=40 W.

After the second round of allocation, the remaining power allocated to the second charging output port 302 is C2=total power assigned-Pmin_c2=40 W−30 W=10 W. The remaining power after the second round is P2_out=P0_out−C1-C2=20 W−10 W−10 W=0, leaving no remaining power, and thus the remaining power allocation ends. This means that the total power assigned to the first charging output port 301 is the first preset power, i.e., 30 W, and the total power assigned to the second charging output port 302 is (Pmin_c2+P1_out)=40 W.

### III. When Three Charging Output Ports are Connected to Power-Receiving Devices

According to the priority order of the charging output ports connected to power-receiving devices, these three charging output ports are defined as the first charging output port 301, the second charging output port 302, and the third charging output port 303. The following preset values are shown in Table 2:

TABLE 2

| | the first | the second | the third |
|---|---|---|---|
| | charging | charging | charging |
| Relevant parameters | output port | output port | output port |
| Minimum output power | 20 W | 30 W | 40 w |
| (Pmin) | | | |
| Maxmum output power | 40 W | 50 W | 100 w |
| (Pmax) | | | |
| Requested load power | 30 W | 60 W | 100 w |
| Preset power | 30 W | 50 W | 100 w |

Assume Pmax_out=180 W. Since Pmax_out=(the first preset power+the second preset power+the third preset power), the power configuration unit 201 assigns to three charging output ports (301, 302, and 303) powers equal to their preset powers. That is, the power allocated to the first charging output port 301 is 30 W, the power allocated to the second charging output port 302 is 50 W, and the power allocated to the third charging output port 303 is 100 W.

Assume Pmax_out=90 W. Since Pmax_out=(Pmin_c1+Pmin_c2+Pmin_c3), the power configuration unit 201 assigns to the three charging output ports (301, 302, and 303) powers equal to their minimum output powers. That is, the power allocated to the first charging output port 301 is 20 W, the power allocated to the second charging output port 302 is 30 W, and the power allocated to the third charging output port 303 is 40 W.

Assume Pmax_out=150 W. Since (Pmin_c1+Pmin_c2+Pmin_c3)<Pmax_out<(the first preset power+the second preset power+the third preset power), the power configuration unit 201 first ensures that each of the three charging output ports (301, 302, and 303) receives its minimum output power. At this point, the remaining available power is P0_out=Pmax_out−(Pmin_c1+Pmin_c2+Pmin_c3)=150 W−90 W=60 W. The rule for distributing this remaining 60 W of power is as follows:

During the first round of remaining power allocation, the power configuration unit 201 assigns to the first charging output port 301 a total power equal to the smaller value between (Pmin_c1+remaining power P0_out) and the first preset power. Since (Pmin_c1+P0_out)=80 W and the first preset power is 30 W, and the first preset power is less than (Pmin_c1+P0_out), the power configuration unit 201 assigns the first preset power of 30 W as the total power for the first charging output port 301. After the first round, the remaining power allocated to the first charging output port 301 is C1=total power assigned-Pmin_c1=30 W−20 W=10 W, and the remaining power is P1_out=P0_out−C1=60 W−10 W=50 W. Since P1 out>0, a second round of remaining power allocation is performed.

During the second round of remaining power allocation, the power configuration unit 201 assigns to the second charging output port 302 a total power equal to the smaller value between (Pmin_c2+remaining power P1_out) and the second preset power. Since (Pmin_c2+P1_out)=80 W and the second preset power is 50 W, the power configuration unit 201 assigns the second preset power of 50 W as the total power for the second charging output port 302. After the second round, the additional power obtained by the second charging output port 302 is C2=total power assigned-Pmin_c2=50 W−30 W=20 W, and the remaining power is P2_out=P0_out−C1-C2=60 W−10 W−20 W=30 W. Since P2_out>0, a third round of remaining power allocation is performed.

During the third round of remaining power allocation, the power configuration unit 201 assigns to the third charging output port 303 a total power equal to the smaller value between (Pmin_c3+remaining power P2_out) and the third preset power. Since (Pmin_c3+P2_out)=70 W and the third preset power is 100 W, the power configuration unit 201 assigns (Pmin_c3+P2_out)=70 W as the total power for the third charging output port 303. After the third round, the additional power obtained by the third charging output port 303 is C3=total power assigned-Pmin_c3=70 W−40 W=30 W, and the remaining power is P3_out=P0_out−C1−C2−C3=60 W−10 W−20 W−30 W=0. Since P3_out=0, the power allocation ends. This means that the total power assigned to the first charging output port 301 and the second charging output port 302 are their preset power, 30 W and 50 W, respectively, and the total power assigned to the third charging output port 303 is (Pmin_c3+P2_out)=70 W.

### Embodiment 2

This embodiment provides a portable energy storage device capable of simultaneous multi-port discharge. Its structural design and power allocation logic are basically the same as those of Embodiment 1. The main difference is that, in the portable energy storage device provided in Embodiment 1, the charging output ports have different priority levels. In contrast, in the portable energy storage device provided in this embodiment, the lowest-priority charging output ports include at least two ports. For these lowest-priority charging output ports, during the allocation of remaining power, since they share the same priority level, the remaining power is evenly distributed among them. Specifically:

The portable energy storage device provided in this embodiment includes at least three charging output ports and a power configuration unit 201. The power configuration unit 201 is configured to allocate power to the charging output ports connected to power-receiving devices (it should be understood that if a charging output port is not connected to a power-receiving device, no power will be allocated to that port). In the present invention, a power-receiving device refers to a device being charged, such as a mobile phone, camera, or the like.

The charging output ports are preset with a priority order for power allocation. For charging output ports with higher priority, the power configuration unit 201 gives precedence to meeting the required power of those ports during power allocation. For the lowest-priority charging output ports that share the same priority, if there is any remaining power available, the power configuration unit 201 evenly distributes the remaining power among them. Each charging output port is preset with a minimum output power and a maximum output power. The minimum output power refers to the minimum power that the power configuration unit will assign to the port, while the maximum output power refers to the maximum power that the power configuration unit will assign to the port.

Define the maximum total output power of the portable energy storage device provided in this embodiment as Pmax_out. The sum of the preset minimum output powers of all charging output ports is ≤Pmax_out, and the minimum output power of each charging output port is ≤its maximum output power. The maximum output power of each charging output port is ≤Pmax_out. Define Y as the number of charging output ports connected to power-receiving devices. Among these Y charging output ports, x ports share the same priority, which is the lowest priority, while the remaining (Y−x) charging output ports have different priorities. Then:

\textcircled{1} When Y=1, that is, only one charging output port is connected to a power-receiving device, regardless of whether this port is of the lowest priority or another priority, x ports share the same priority, which is the lowest priority. The preset power refers to the smaller value between the maximum output power of the port and the load request power.

\textcircled{2} When Y≥2 and these charging output ports have different priorities, the power allocation rules for these ports are the same as in Embodiment 1. That is:

Sort these charging output ports in descending order of priority, and sequentially define them as the first charging output port through the Y-th charging output port. Their minimum output powers are sequentially defined as Pmin_c1 through Pmin_cY, and the smaller values between their maximum output powers and load request powers are defined as the first preset power through the Y-th preset power.

If Pmax_out=(Pmin_c1+ . . . +Pmin_cY), the power configuration unit assigns each charging output port connected to a power-receiving device its corresponding minimum output power.

If Pmax_out≥(first preset power+ . . . +Y-th preset power), the power configuration unit assigns each charging output port connected to a power-receiving device its corresponding preset power.

If (Pmin_c1+ . . . +Pmin_cY)<Pmax_out<(first preset power+ . . . +Y-th preset power), the power configuration unit 201 first satisfies the minimum output power of the charging output ports, and then sequentially allocates the remaining power to the ports in order of priority. Define the initial amount of remaining power as P0_out, where P0_out=Pmax_out−(Pmin_c1+ . . . +Pmin_cY). The allocation rules are as follows:

During the first round of remaining power allocation, the power configuration unit assigns the first charging output port a total power equal to the smaller value between (Pmin_c1+remaining power P0_out) and the first preset power. Define the additional power obtained by the first charging output port after the first round of allocation as C1, where C1=total power allocated to the first charging output port−Pmin_c1. Define the remaining power left after the first round as P1_out, where P1_out=P0_out−C1. If P1_out=0, the power allocation ends. If P1_out>0, the remaining power is further allocated according to the following rules until the remaining power Pk_out equals 0, at which point the power allocation is completed:

During the k-th round of remaining power allocation, the power configuration unit assigns the k-th charging output port a total power equal to the smaller value between (Pmin_ck+remaining power P(k−1)_out) and the k-th preset power. Define the additional power obtained by the k-th charging output port after the k-th round as Ck, where Ck=total power allocated to the k-th charging output port minus Pmin_ck. Define the remaining power left after the k-th round as Pk_out, where Pk_out=P0_out−C1− . . . −Ck, where k is a positive integer such that 2≤k≤Y.

\textcircled{3} When Y≥2 and among these Y charging output ports, x ports share the same priority and are the lowest priority, if Y=x, and Pmax_out≥the sum of the preset powers of these Y charging output ports, the power configuration unit assigns each charging output port connected to a power-receiving device its corresponding preset power; otherwise, if Pmax_out<the sum of the preset powers of these ports, the power configuration unit first satisfies the minimum output power of these ports and then evenly distributes the remaining power among them.

\textcircled{4} When Y≥3 and among these Y charging output ports, x ports share the same priority and are the lowest priority, where Y>x≥2 (in this case, the remaining (Y−x) charging output ports have different priorities):

Sort the charging output ports from high to low priority and sequentially define them as the first to the Y-th charging output ports, where the (Y−x+1)-th to the Y-th charging output ports share the same priority. For these x lowest-priority charging output ports, their internal sequence is unrestricted. After sorting by priority, define the minimum output powers of these ports as Pmin_c1 to Pmin_cY, and define the first through the Y-th preset powers as the smaller of each port's maximum output power and load request power.

If Pmax_out=(Pmin_c1+ . . . +Pmin_cY), the power configuration unit allocates to each connected charging output port its corresponding minimum output power.

If Pmax_out≥(first preset power+ . . . +Y-th preset power), the power configuration unit allocates to each connected charging output port its corresponding preset power.

If (Pmin_c1+ . . . +Pmin_cY)<Pmax_out<(first preset power+ . . . +Y-th preset power), the power configuration unit 201 first satisfies the minimum output power of these charging output ports (i.e., the power configuration unit initially assigns each connected charging output port its corresponding minimum output power), and then sequentially distributes the remaining power according to priority. The initial amount of remaining power is defined as P0_out, where P0_out=Pmax_out−(Pmin_c1+ . . . +Pmin_cY). The distribution rules are as follows:

During the first round of remaining power distribution, the power configuration unit 201 allocates to the first charging output port 301 a total power equal to the smaller of (Pmin_c1+remaining power P0_out) and the first preset power. After the first round of remaining power distribution, the remaining power obtained by the first charging output port 301 is defined as C1, where C1=total power allocated to the first charging output port 301−Pmin_c1. The remaining power after the first round is defined as P1_out, where P1_out=P0_out−C1. If P1_out=0, the power distribution ends. If P1_out>0 and at this time only x charging output ports have not yet received any remaining power, the power configuration unit 201 evenly distributes P1_out among these x charging output ports, and the power distribution ends. If P1_out>0 and the number of charging output ports that have not yet received remaining power is greater than x, the power configuration unit 201 continues to distribute the remaining power according to the remaining power distribution rules until either condition one or condition two is met.

The remaining power distribution rule is as follows: In the k-th round of remaining power distribution, the power configuration unit 201 allocates to the k-th charging output port a total power equal to the smaller of (Pmin_ck+remaining power Pk-1_out) and the k-th preset power. After the k-th round of remaining power distribution, the remaining power obtained by the k-th charging output port is defined as Ck, where Ck=total power allocated to the k-th charging output port−Pmin_ck. The remaining power after the k-th round is defined as Pk_out, where Pk_out=P0_out−C1 . . . Ck.

Condition one is that the remaining residual power Pk_out is 0; Condition two is that the remaining power Pk_out>0 and the charging output ports from (Y−x+1) to Y have not yet been allocated remaining power. If condition one is reached first, the power allocation ends; if condition two is reached first, the remaining residual power Pk_out is evenly distributed among the charging output ports from (Y−x+1) to Y, and the power allocation ends, where k is a positive integer and 2≤k≤Y−x. It should be noted that after the residual power is evenly distributed to the charging output ports from (Y−x+1) to Y, if a port receives a sum of residual power and minimum output power greater than or equal to its preset power, the port's final operating power is equal to the preset power; if the sum is less than the preset power, the port's final operating power is equal to the sum of the residual power and minimum output power.

The portable energy storage device provided in this embodiment can ensure that when multiple charging output ports are connected to power-receiving devices and the total power required by these devices exceeds the maximum power that the device can provide, all ports can still operate at their respective minimum output power. Furthermore, after multiple charging output ports are connected to power-receiving devices and power is allocated according to the above rules, if during operation a power-receiving device connected to a certain charging output port is removed, causing a change in the number of charging output ports connected to power-receiving devices, the power is reallocated according to the current number of connected ports based on the above rules. This allows the power released from the removed device to be distributed to the remaining connected ports, enabling the portable energy storage device to output power as close as possible to its maximum total output power and achieving dynamic adjustment. In addition, in this embodiment, except for the lowest-priority charging output ports, which include at least two ports, all other charging output ports have different, preset priorities. Therefore, when using the device, the user can determine the priority order of multiple power-receiving devices according to actual needs.

For ease of understanding the technical solution provided in this embodiment, the following specific numerical values are given for further illustration:

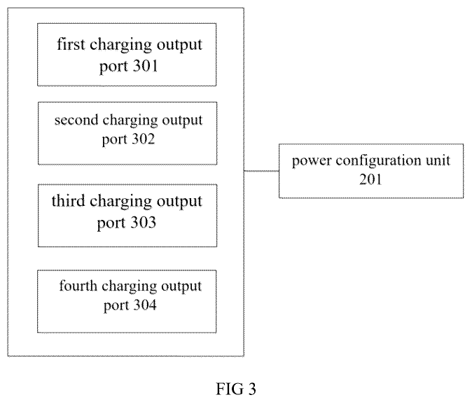

Assume that the portable energy storage device is equipped with four charging output ports, namely Port W, Port A, Port C1, and Port C2, respectively. The priorities of these four charging output ports are set in the following order: W>A>C1=C2. Accordingly, as shown in FIG. 3, when sequentially numbered according to priority, Port W is the first charging output port 301, Port A is the second charging output port 302, Port C1 is the third charging output port 303, and Port C2 is the fourth charging output port 304. When these four charging output ports are connected to power-receiving devices, the corresponding power data are listed in Table 3:

TABLE 3

| Relevant parameters | Port W | Port A | Port C1 | Port C2 |
|---|---|---|---|---|
| Minimum output power (Pmin) | 20 W | 30 W | 50 w | 50 w |
| Maxmum output power (Pmax) | 40 W | 50 W | 70 w | 70 w |
| Requested load power | 30 W | 60 W | 80 w | 80 w |
| Preset power | 30 W | 50 W | 70 w | 70 w |

\textcircled{1} If only Port W is connected to a power-receiving device, since the smaller value between its maximum output power and the load request power is 30 W, the power configuration unit 201 allocates 30 W to Port W. Similarly, if only Port C1 is connected to a power-receiving device, since the smaller value between its maximum output power and the load request power is 70 W, the power configuration unit 201 allocates 70 W to Port C1.

\textcircled{2} When only Port C1 and Port C2 are connected to power-receiving devices, assuming that Pmax_out=110 W, as Pmax_out<(the sum of the preset powers of Port C1 and Port C2), the power configuration unit 201 first allocates the minimum output powers to Port C1 and Port C2. The remaining power at this stage is Pmax_out−(Pmin_C1+Pmin_C2)=10 W, which is then evenly distributed between Port C1 and Port C2, so that the final total power allocated to each port is 55 W.

\textcircled{3} When only Ports W, A, and C1 are connected to power-receiving devices, assuming Pmax_out=140 W, and since (Pmin_W+Pmin_A+Pmin_C1)<Pmax_out<(the sum of the preset powers of Ports W, A, and C1), the power configuration unit 201 first allocates the minimum output powers to Ports W, A, and C1, and then sequentially distributes the remaining power according to the priority order. The initial remaining power is defined as P0_out=Pmax_out−(Pmin_W+Pmin_A+Pmin_C1)=140 W−100 W=40 W. The allocation proceeds as follows:

During the first round of remaining power allocation, the power configuration unit 201 assigns to Port W a total power equal to the smaller of (Pmin_W+P0_out) and the preset power of Port W. Here, (Pmin_W+P0_out) equals 60 W, while the preset power of Port W is 30 W; thus, the total power allocated to Port W is 30 W. After the first round, the remaining power allocated to Port W is C1=total allocated power−Pmin_W=30 W−20 W=10 W, and the remaining power after the first round is P1_out=P0_out−C1=40 W−10 W=30 W.

Since P1_out>0, the second round of remaining power allocation continues. During this second round, the power configuration unit 201 assigns to port A a total power equal to the smaller of (Pmin_A+remaining power P1_out) and the preset power of port A. Here, (Pmin_A+remaining power P1_out)=60 W, and the preset power of port A is 50 W. Therefore, the total power allocated to port A by the power configuration unit 201 is 50 W. After the second round of remaining power allocation, the remaining power obtained by port A is C2, calculated as C2=total power allocated to port A−Pmin_A=50 W−30 W=20 W. The remaining power after the second round is P2_out, calculated as P2_out=P0_out−C1-C2=10 W.

Since P2_out>0, the third round of remaining power allocation continues. During this third round, the power configuration unit 201 assigns to port C1 a total power equal to the smaller of (Pmin_C1+remaining power P2_out) and the preset power of port C1. Here, (Pmin_C1+remaining power P2_out)=60 W, and the preset power of port C1 is 70 W. Therefore, the total power allocated to port C1 by the power configuration unit 201 is 60 W. After the third round of remaining power allocation, the remaining power obtained by port C1 is C3, calculated as C3=total power allocated to port C1-Pmin_C1=60 W−50 W=10 W. The remaining power after the third round is P3_out, calculated as P3_out=P0_out−C1−C2=0. Therefore, the power allocation process is complete.

\textcircled{4} If only port W, port C1, and port C2 are connected to power-receiving devices, assuming Pmax_out=130 W, since (Pmin_W+Pmin_C1+Pmin_C2)<Pmax_out<(preset power of W+preset power of port C1+preset power of port C2), the power configuration unit 201 first satisfies the minimum output power of port W, port C1, and port C2, and then allocates the remaining power sequentially according to priority. The initial amount of remaining power is P0_out=Pmax_out−(Pmin_W+Pmin_C1+Pmin_C2)=10 W. The allocation rules are as follows:

During the first round of remaining power allocation, the power configuration unit 201 assigns to Port W a total power equal to the smaller of (Pmin_W+remaining power P0_out) and the preset power of Port W. Here, (Pmin_W+P0_out)=30 W, and the preset power of Port W is also 30 W. Therefore, the total power allocated to Port W by the power configuration unit 201 is 30 W. After the first round of remaining power allocation, the remaining power allocated to Port W is C1=total allocated power−Pmin_W=30 W−20 W=10 W. The remaining power after the first round is P1_out=P0_out−C1=10 W−10 W=0. Since P1_out=0, the power allocation process ends. This means that the total power allocated to Port W is 30 W, and each of Port C1 and Port C2 receives its respective minimum output power of 50 W.

Assuming Pmax_out=140 W, since (Pmin_W+Pmin_C1+Pmin_C2)<Pmax_out<(preset power of port W+preset power of port C1+preset power of port C2), the power configuration unit 201 first satisfies the minimum output power of port W, port C1, and port C2, and then allocates the remaining power sequentially according to priority. The initial amount of remaining power is P0_out=Pmax_out−(Pmin_W+Pmin_C1+Pmin_C2)=20 W. The allocation rules are as follows:

During the first round of remaining power allocation, the power configuration unit 201 assigns to Port W a total power equal to the smaller of (Pmin_W+remaining power P0_out) and the preset power of Port W. Here, (Pmin_W+remaining power P0_out)=30 W, and the preset power of Port W is also 30 W. Therefore, the total power allocated to Port W by the power configuration unit 201 is 30 W. After the first round of remaining power allocation, the remaining power allocated to Port Wis C1=total power allocated to Port W-Pmin_W=10 W. The remaining power after the first round is P1_out=P0_out−C1=10 W. Since P1_out>0 and at this time, only the second and third charging output ports 302 and 303 (i.e., C1 and C2) have not yet been allocated any remaining power, the power configuration unit 201 evenly distributes P1_out to these ports, with each of Port C1 and Port C2 receiving 5 W. The power allocation process is thus complete, which means that the total power allocated to Port W is 30 W, and the total power allocated to Port C1 and Port C2 is 55 W each.

\textcircled{4} If ports W, A, C1, and C2 are all connected to power-receiving devices:

Assuming Pmax_out=250 W, since Pmax_out>(preset power of ports W+A+C1+C2), the power configuration unit 201 allocates power to ports W, A, C1, and C2 equal to their respective preset powers. Specifically, the total power allocated to Port W is 30 W, to Port A is 50 W, to Port C1 is 70 W, and to Port C2 is 70 W.

Assuming Pmax_out=150 W, since Pmax_out=(Pmin_W+Pmin_A+Pmin_C1+Pmin_C2), the power configuration unit 201 allocates power to ports W, A, C1, and C2 equal to their respective minimum output powers. Specifically, the total power allocated to Port W is 20 W, to Port A is 30 W, to Port C1 is 50 W, and to Port C2 is 50 W.

Assuming Pmax_out=170 W, since (Pmin_W+Pmin_A+Pmin_C1+Pmin_C2)<Pmax_out<(preset power of ports W+A+C1+C2), the power configuration unit 201 first allocates the minimum output power to ports W, A, C1, and C2. The initial remaining power is then P0_out=Pmax_out−(Pmin_W+Pmin_A+Pmin_C1+Pmin_C2)=170 W−150 W=20 W. The allocation rules for this remaining 20 W are as follows:

During the first round of remaining power allocation, the power configuration unit 201 assigns to port W a total power equal to the smaller of (Pmin_W+remaining power P0_out) and the preset power of port W. Here, (Pmin_W+remaining power P0_out)=40 W, and the preset power of port W is 30 W. Therefore, the total power allocated to port W by the power configuration unit 201 is 30 W. The remaining power obtained by port W is C1=total power allocated to W port−Pmin_W=30 W−20 W=10 W. The remaining power after the first round is P1_out=P0_out−C1=20 W−10 W=10 W. Since P1_out>0 and there are still three charging output ports that have not yet received the remaining power, while two of these ports have the same lowest priority, the second round of remaining power allocation is carried out.

During the second round of remaining power allocation, the power configuration unit 201 assigns to port A a total power equal to the smaller of (Pmin_A+remaining power P1_out) and the preset power of port A. Here, (Pmin_A+remaining power P1_out)=40 W, and the preset power of port A is 50 W. Therefore, the total power allocated to port A by the power configuration unit 201 is 40 W. After the second round of remaining power allocation, the remaining power obtained by port A is C2=total power allocated to port A-Pmin_A=40 W−30 W=10 W. The remaining power after the second round is P2_out=P0_out−C1−C2=20 W−10 W−10 W=0. Since the remaining power P2_out=0, the termination condition is reached, and the power allocation process ends. This means that the total power allocated to port W is 30 W, to port A is 40 W, and to port C1 and port C2 is their respective minimum output powers, i.e., 50 W each.

Assuming Pmax_out=200 W, since (Pmin_W+Pmin_A+Pmin_C1+Pmin_C2)<Pmax_out<(preset power of port W+preset power of port A+preset power of port C1+preset power of port C2), the power configuration unit 201 first satisfies the minimum output power of port W, port A, port C1, and port C2. At this point, the remaining power is P0_out=Pmax_out−(Pmin_W+Pmin_A+Pmin_C1+Pmin_C2)=200 W−150 W=50 W. The allocation rules for this 50 W of remaining power are as follows:

During the first round of remaining power allocation, the power configuration unit 201 assigns to port W a total power equal to the smaller of (Pmin_W+remaining power P0_out) and the preset power of port W. Here, (Pmin_W+remaining power P0_out)=70 W, and the preset power of port W is 30 W. Therefore, the total power allocated to port W by the power configuration unit 201 is 30 W. The remaining power obtained by port W is C1=total power allocated to port W−Pmin_W=30 W−20 W=10 W. The remaining power after the first round is P1_out=P0_out−C1=50 W−10 W=40 W. Since P1 out>0 and there are still three charging output ports that have not yet received the remaining power, with two of them having the same lowest priority, a second round of remaining power allocation is carried out.

During the second round of remaining power allocation, the power configuration unit 201 assigns to port A a total power equal to the smaller of (Pmin_A+remaining power P1_out) and the preset power of port A. Here, (Pmin_A+remaining power P1_out)=70 W, and the preset power of port A is 50 W. Therefore, the total power allocated to port A by the power configuration unit 201 is 50 W. After the second round of remaining power allocation, the remaining power obtained by port A is C2=total power allocated to port A-Pmin_A=50 W−30 W=20 W. The remaining power after the second round is P2_out=P0_out−C1−C2=50 W−10 W−20 W=20 W.

Since P2_out>0 and only the two lowest-priority ports, port C1 and port C2, have not yet received the remaining power, the previous remaining power allocation rules are terminated, and P2_out is evenly distributed between port C1 and port C2. Port C1 and port C2 each receive 10 W. Adding their minimum output powers, the total power allocated to port C1 is 60 W, and the total power allocated to port C2 is also 60 W. At this point, the power configuration is complete. For the 200 W maximum output of the portable energy storage device, port W receives 30 W, port A receives 50 W, port C1 and port C2 each receive 60 W.

Specifically, among port W, port A, port C1, and port C2, port W and port A can be unidirectional ports that only discharge, while port C1 and port C2 can be bidirectional ports capable of both charging and discharging.

### Embodiment 3

This embodiment provides a power allocation method for a portable energy storage device, applied to the portable energy storage device described in Embodiment 1. The structure of the portable energy storage device is as described in Embodiment 1, and it includes at least two charging output ports and a power configuration unit. The power configuration unit is configured to allocate power to the charging output ports connected to power-receiving devices. The charging output ports are preconfigured with a priority order for power allocation, and each charging output port is preconfigured with a minimum output power and a maximum output power.

Define the maximum total output power of the portable energy storage device as Pmax_out (in this application, the sum of the minimum output powers of all charging output ports is pre-set to be ≤Pmax_out, and the minimum output power of each charging output port≤its maximum output power, while the maximum output power of each charging output port≤Pmax_out). Define the number of charging output ports connected to power-receiving devices as Y. The power allocation method includes:

When Y=1, the power configuration unit allocates power to the single charging output port equal to the smaller of its maximum output power and the requested load power.

When Y≥2 and the Y charging output ports have different priorities, these charging output ports are sorted in descending order of priority and sequentially defined as the first charging output port through the Y-th charging output port. Their minimum output powers are sequentially defined as Pmin_c1 through Pmin_cY, and their maximum output powers or the requested load powers, whichever is smaller, are sequentially defined as the first preset power through the Y-th preset power.

If Pmax_out=(Pmin_c1+ . . . +Pmin_cY), the power configuration unit allocates to each charging output port connected to a power-receiving device its corresponding minimum output power.

If Pmax_out≥(first preset power+ . . . +Y-th preset power), the power configuration unit allocates to each charging output port connected to a power-receiving device its corresponding preset power.

If (Pmin_c1+ . . . +Pmin_cY)<Pmax_out<(first preset power+ . . . +Y-th preset power), the power configuration unit first satisfies the minimum output power of these charging output ports, and then allocates the remaining power sequentially according to priority. Define the initial amount of remaining power as P0_out, where P0_out=Pmax_out−(Pmin_c1+ . . . +Pmin_cY). The allocation rules are as follows:

During the first round of remaining power allocation, the power configuration unit allocates to the first charging output port a total power equal to the smaller of (Pmin_c1+remaining power P0_out) and the first preset power. Define the remaining power obtained by the first charging output port after the first round as C1, where C1=total power allocated to the first charging output port−Pmin_c1. Define the remaining power after the first round as P1_out, where P1_out=P0_out−C1. If P1_out=0, the power allocation process ends. If P1_out>0, the remaining power is further allocated according to the following rules until the remaining power Pk_out=0, at which point the power allocation process ends:

During the k-th round of remaining power allocation, the power configuration unit allocates to the k-th charging output port a total power equal to the smaller of (Pmin_ck+remaining power Pk-1_out) and the k-th preset power. Define the remaining power obtained by the k-th charging output port after the k-th round as Ck, where Ck=total power allocated to the k-th charging output port−Pmin_ck. Define the remaining power after the k-th round as Pk_out, where Pk_out=P0_out−C1− . . . −Ck, with k being a positive integer and k≥2.

### Embodiment 4

This embodiment provides a power allocation method for a portable energy storage device, applied to the portable energy storage device described in Embodiment 2. As described in Embodiment 2, the portable energy storage device includes at least three charging output ports and a power configuration unit. The power configuration unit is configured to allocate power to the charging output ports connected to power-receiving devices. The charging output ports are preconfigured with a priority order for power allocation, and each charging output port is preconfigured with a minimum output power and a maximum output power.

Define the maximum total output power of the portable energy storage device as Pmax_out, with the sum of the minimum output powers of all charging output ports pre-set to be ≤Pmax_out, the minimum output power of each charging output port≤its maximum output power, and the maximum output power of each charging output port≤Pmax_out. Define the number of charging output ports connected to power-receiving devices as Y. Among these Y charging output ports, the number of ports with the same lowest priority is x, and the remaining (Y−x) charging output ports have different priorities.

The method includes:

When Y=1, that is, only one charging output port is connected to a power-receiving device, regardless of whether this charging output port has the lowest priority (in this case, x=1, Y−x=0) or another priority (in this case, x=0, Y−x=1), the power configuration unit allocates to the charging output port a power equal to the smaller of its maximum output power and the requested load power.

When Y≥2 and Y=x, that is, all Y charging output ports have the same lowest priority, if Pmax_out≥the sum of the preset powers of these Y charging output ports, the power configuration unit allocates to each charging output port connected to a power-receiving device its corresponding preset power. If Pmax_out<the sum of the preset powers of these charging output ports, the power configuration unit first satisfies the minimum output power of these ports, and then evenly distributes the remaining power.

When Y≥2 and x=1, that is, the Y charging output ports have different priorities, the discharge power is allocated according to the method described in Embodiment 3, which will not be repeated here.

When Y≥3 and 2≤x<Y, the charging output ports are sorted in descending order of priority and sequentially defined as the first charging output port through the Y-th charging output port. Among them, the (Y−x+1)-th through Y-th charging output ports have the same priority. The minimum output powers of these charging output ports are sequentially defined as Pmin_c1 through Pmin_cY, and the smaller of their maximum output powers and requested load powers are sequentially defined as the first preset power through the Y-th preset power.

If Pmax_out=(Pmin_c1+ . . . +Pmin_cY), the power configuration unit allocates to each charging output port connected to a power-receiving device its corresponding minimum output power.

If Pmax_out≥(first preset power+ . . . +Y-th preset power), the power configuration unit allocates to each charging output port connected to a power-receiving device its corresponding preset power.

If (Pmin_c1+ . . . +Pmin_cY)<Pmax_out<(first preset power+ . . . +Y-th preset power), the power configuration unit first satisfies the minimum output power of these charging output ports, and then sequentially allocates the remaining power according to priority. Define the initial amount of remaining power as P0_out, where P0_out=Pmax_out−(Pmin_c1+ . . . +Pmin_cY). The allocation rules are as follows:
During the first round of remaining power allocation, the power configuration unit allocates to the first charging output port a total power equal to the smaller of (Pmin_c1+remaining power P0_out) and the first preset power. Define the remaining power obtained by the first charging output port after the first round as C1, where C1=total power allocated to the first charging output port−Pmin_c1. Define the remaining power after the first round as P1_out, where P1_out=P0_out−C1. If P1_out=0, the power allocation process ends. If P1_out>0 and only x charging output ports have not yet received the remaining power, the power configuration unit evenly distributes P1_out among these x charging output ports, and the power allocation process ends. If P1_out>0 and the number of charging output ports that have not yet received the remaining power is greater than x, the power configuration unit continues to allocate the remaining power according to the following remaining power allocation rules until either Condition 1 or Condition 2 is met:
The remaining power allocation rule is as follows: During the k-th round of remaining power allocation, the power configuration unit allocates to the k-th charging output port a total power equal to the smaller of (Pmin_ck+remaining power Pk-1_out) and the k-th preset power. Define the remaining power obtained by the k-th charging output port after the k-th round as Ck, where Ck=total power allocated to the k-th charging output port−Pmin_ck. Define the remaining power after the k-th round as Pk_out, where Pk_out=P0_out−C1− . . . −Ck.

Condition 1 is that the remaining power Pk_out is 0. Condition 2 is that the remaining power Pk_out>0 and only x charging output ports have not yet received the remaining power. If Condition 1 is reached first, the power allocation process ends. If Condition 2 is reached first, the remaining power Pk_out is evenly distributed among the remaining x charging output ports, and the power allocation process ends. Here, k is a positive integer and k≥2.

The types of charging output ports mentioned in the present invention are not limited; multiple charging output ports may be of the same type or of different types. In the present invention, the total power allocated to a charging output port is generally also its operating power. However, there are two special cases: after the remaining power is evenly distributed among the charging output ports with the lowest priority, if the total power allocated to a port, calculated as (remaining power+minimum output power), is greater than or equal to the port's preset power, then the port will ultimately operate at its preset power. If a port receives a total power equal to its minimum output power, and this minimum output power exceeds the port's requested load power, then the port will ultimately operate at the requested load power.

The specific embodiments of the present invention have been described above. Based on the foregoing description, those skilled in the art can make various modifications and changes without departing from the scope and spirit of the present invention.

1. A portable energy storage device capable of simultaneous multi-port discharge, wherein:
comprising a power configuration unit and at least two charging output ports, wherein the power configuration unit is configured to allocate power to the charging output ports connected to power-receiving devices, each charging output port being preset with a power distribution priority, a minimum output power, and a maximum output power; defining the maximum total output power of the energy storage device as Pmax_out, and the number of charging output ports connected to power-receiving devices as Y, defining, in order from highest to lowest priority, the ports as the first to the Y-th charging output ports, their minimum output powers as Pmin_c1 to Pmin_cY, and the smaller of their maximum output power and load request power as the first to the Y-th preset powers; wherein, when Y≥2 and the Y charging output ports have different priorities:
if (Pmin_c1+ . . . +Pmin_cY)<Pmax_out<(first preset power+ . . . +Y-th preset power), the power configuration unit first satisfies the minimum output power of said ports, and then allocates the remaining power sequentially according to priority, defining the initial amount of remaining power as P0_out, and the remaining power allocation rule as follows:
during the first round of remaining power allocation, the power configuration unit allocates to the first charging output port a total power equal to the smaller of (Pmin_c1+remaining power P0_out) and the first preset power; defining the remaining power obtained by the first charging output port after the first round of allocation as C1, C1=total power allocated to the first charging output port−Pmin_c1; defining the remaining power after the first round as P1_out, P1_out=P0_out−C1; if P1_out=0, power allocation ends; if P1_out>0, the following rule is applied to continue allocating remaining power until the remaining power Pk_out=0, thereby ending power allocation: during the k-th round of remaining power allocation, the power configuration unit allocates to the k-th charging output port the smaller of (Pmin_ck+remaining power Pk-1_out) and the k-th preset power as the total power obtained; defining the remaining power obtained by the k-th charging output port after the k-th round as Ck, Ck=total power allocated to the k-th charging output port−Pmin_ck; defining the remaining power after the k-th round as Pk_out, Pk_out=P0_out−C1 . . . Ck, where k is a positive integer and k≥2.

2. The portable energy storage device capable of simultaneous multi-port discharge according to claim 1, wherein,
when Y>2 and all of the Y charging output ports have the same lowest priority, if Pmax_out<the sum of the preset powers of these ports, the power configuration unit first satisfies the minimum output power of said ports and then evenly allocates the remaining power.

3. The portable energy storage device capable of simultaneous multi-port discharge according to claim 1, wherein,
when Y≥3 and among the Y charging output ports, x ports have the same lowest priority and the remaining (Y−x) ports have different priorities, where 2≤x<Y:
if (Pmin_c1+ . . . +Pmin_cY)<Pmax_out<(first preset power+ . . . +Y-th preset power), the power configuration unit first satisfies the minimum output power of said ports, and then allocates the remaining power sequentially according to priority, defining the initial amount of remaining power as P0_out, with the allocation rule as follows:
during the first round of remaining power allocation, the power configuration unit allocates to the first charging output port a total power equal to the smaller of (Pmin_c1+remaining power P0_out) and the first preset power; defining the remaining power obtained by the first charging output port after the first round as C1, C1=total power allocated to the first charging output port−Pmin_c1; defining the remaining power after the first round as P1_out, P1_out=P0_out−C1; if P1_out=0, power allocation ends; if P1_out>0 and only x charging output ports remain unallocated with remaining power, the power configuration unit evenly distributes the remaining power P1_out to the x charging output ports, and power allocation ends; if P1_out>0 and more than x charging output ports remain unallocated, the power configuration unit continues allocation according to the following rule until either Condition 1 or Condition 2 is met:
the remaining power allocation rule is as follows: during the k-th round of remaining power allocation, the power configuration unit allocates to the k-th charging output port the smaller of (Pmin_ck+remaining power Pk-1_out) and the k-th preset power as the total power obtained; the remaining power obtained by the k-th charging output port after the k-th round of allocation is defined as Ck, and the remaining power thereafter as Pk_out, where Ck=total power allocated to the k-th charging output port−Pmin_ck, and Pk_out=P0_out−C1− . . . Ck;
the condition 1 is that the remaining power Pk_out is 0; the condition 2 is that the remaining power Pk_out>0 and, at this point, only x charging output ports have not yet been allocated remaining power; if Condition 1 is met first, the power allocation ends; if Condition 2 is met first, the remaining power Pk_out is evenly distributed among the remaining x charging output ports, and the power allocation ends, where k is a positive integer and k≥2.

4. The portable energy storage device capable of simultaneous multi-port discharge according to claim 1, wherein,
if Pmax_out=(Pmin_c1+ . . . +Pmin_cY), the power configuration unit allocates to each charging output port connected to a power-receiving device its corresponding minimum output power; if Pmax_out≥(first preset power+ . . . +Y-th preset power), the power configuration unit allocates to each charging output port connected to a power-receiving device its corresponding preset power.

5. The portable energy storage device capable of simultaneous multi-port discharge according to claim 1, wherein,
when Y=1, the power configuration unit allocates to the charging output port a power equal to the smaller of its maximum output power and the requested load power as the allocated power.

6. The portable energy storage device capable of simultaneous multi-port discharge according to claim 1, wherein,
the portable energy storage device comprises a main control board and one or more independent circuit boards connected to the main control board, the charging output ports provided on the circuit boards, and the power configuration unit being disposed on the main control board.

7. The portable energy storage device capable of simultaneous multi-port discharge according to claim 6, wherein,
the power configuration unit reads preset parameters of the charging output ports, calculates the real-time power demand of each charging output port, and allocates discharge power accordingly, the preset parameters including current and voltage.

8. The portable energy storage device capable of simultaneous multi-port discharge according to claim 6, wherein,
protection circuits are provided on both the circuit boards and the main control board, the protection circuits comprising one or more of: an over-current protection circuit, an over-voltage protection circuit, an over-temperature protection circuit, and a short-circuit protection circuit, and when an abnormal condition is detected, the protection circuit responds and interrupts the power supply of the relevant circuit.

9. A power allocation method for a portable energy storage device, wherein:
the method is applied to the portable energy storage device according to claim 1, comprising: when the number of charging output ports connected to power-receiving devices Y≥2 and all of the Y charging output ports have different priorities: if (Pmin_c1+ . . . +Pmin_cY)<Pmax_out<(first preset power+ . . . +Y-th preset power), the power configuration unit first satisfies the minimum output power of the charging output ports, and then allocates the remaining power sequentially according to priority, defining the initial amount of remaining power as P0_out, with the allocation rule as follows:
during the first round of remaining power allocation, the power configuration unit allocates to the first charging output port a total power equal to the smaller of (Pmin_c1+remaining power P0_out) and the first preset power; defining the remaining power obtained by the first charging output port after the first round as C1, C1=total power allocated to the first charging output port−Pmin_c1; defining the remaining power after the first round as P1_out, P1_out=P0_out−C1; if P1_out=0, power allocation ends; if P1_out>0, the following rule is applied to continue allocation until the remaining power Pk_out=0, thereby ending power allocation: during the k-th round of remaining power allocation, the power configuration unit allocates to the k-th charging output port the smaller of (Pmin_ck+remaining power Pk-1_out) and the k-th preset power as the total power obtained; defining the remaining power obtained by the k-th charging output port after the k-th round as Ck, Ck=total power allocated to the k-th charging output port—Pmin_ck; defining the remaining power after the k-th round as Pk_out, Pk_out=P0_out−C1 . . . Ck, where k is a positive integer and k≥2.

10. The power allocation method for a portable energy storage device according to claim 9, wherein:
when the number of charging output ports connected to power-receiving devices Y≥2 and the Y charging output ports all have the same lowest priority, if Pmax_out<the sum of the preset powers of the charging output ports, the power configuration unit first satisfies the minimum output power of the charging output ports and then evenly allocates the remaining power; when the number of charging output ports connected to power-receiving devices Y≥3 and among the Y charging output ports x ports have the same lowest priority and the remaining (Y−x) ports have different priorities, where 2≤x<Y:
if (Pmin_c1+ . . . +Pmin_cY)<Pmax_out<(first preset power+ . . . +Y-th preset power), the power configuration unit first satisfies the minimum output power of the charging output ports, and then allocates the remaining power sequentially according to priority, defining the initial amount of remaining power as P0_out, with the allocation rule as follows:
during the first round of remaining power allocation, the power configuration unit allocates to the first charging output port the smaller of (Pmin_c1+remaining power P0_out) and the first preset power as the total power obtained; defining the remaining power obtained by the first charging output port after the first round as C1, C1=total power allocated to the first charging output port−Pmin_c1; defining the remaining power after the first round as P1_out, P1_out=P0_out−C1; if P1_out=0, power allocation ends; if P1_out>0 and only x charging output ports remain unallocated with remaining power, the power configuration unit evenly distributes the remaining power P1_out to the x charging output ports, and power allocation ends; if P1_out>0 and more than x charging output ports remain unallocated, the power configuration unit continues allocation according to the following rule until either Condition 1 or Condition 2 is met:
the remaining power allocation rule is as follows: during the k-th round of remaining power allocation, the power configuration unit allocates to the k-th charging output port the smaller of (Pmin_ck+remaining power Pk-1_out) and the k-th preset power as the total power obtained; defining the remaining power obtained by the k-th charging output port after the k-th round as Ck, Ck=total power allocated to the k-th charging output port−Pmin_ck; defining the remaining power after the k-th round as Pk_out, Pk_out=P0_out−C1 . . . Ck;
the condition 1 is that the remaining power Pk_out is 0; the condition 2 is that remaining power Pk_out>0 and only x charging output ports remain unallocated with remaining power; if Condition 1 is met first, power allocation ends; if Condition 2 is met first, the remaining power Pk_out is evenly distributed to the remaining x charging output ports, and power allocation ends, where k is a positive integer and k≥2.

11. The portable energy storage device capable of simultaneous multi-port discharge according to claim 2, wherein,
if Pmax_out=(Pmin_c1+ . . . +Pmin_cY), the power configuration unit allocates to each charging output port connected to a power-receiving device its corresponding minimum output power; if Pmax_out≥(first preset power+ . . . +Y-th preset power), the power configuration unit allocates to each charging output port connected to a power-receiving device its corresponding preset power.

12. The portable energy storage device capable of simultaneous multi-port discharge according to claim 3, wherein,
if Pmax_out=(Pmin_c1+ . . . +Pmin_cY), the power configuration unit allocates to each charging output port connected to a power-receiving device its corresponding minimum output power; if Pmax_out≥(first preset power+ . . . +Y-th preset power), the power configuration unit allocates to each charging output port connected to a power-receiving device its corresponding preset power.

13. The portable energy storage device capable of simultaneous multi-port discharge according to claim 2, wherein,
when Y=1, the power configuration unit allocates to the charging output port a power equal to the smaller of its maximum output power and the requested load power as the allocated power.

14. The portable energy storage device capable of simultaneous multi-port discharge according to claim 3, wherein,
when Y=1, the power configuration unit allocates to the charging output port a power equal to the smaller of its maximum output power and the requested load power as the allocated power.
